(19) United States
(12) Patent Application Publication
(10) Pub. No.: US 2023/0222148 A1
(43) Pub. Date: Jul. 13, 2023

(54) SYSTEMS AND METHODS FOR ATTRIBUTION OF FACTS TO MULTIPLE INDIVIDUALS IDENTIFIED IN TEXTUAL CONTENT

(71) Applicant: Grapevine Solutions, Inc., New York, NY (US)

(72) Inventors: Andrew Reiner, New York, NY (US); Nathaniel Cohen, New York, NY (US)

(21) Appl. No.: 18/151,684

(22) Filed: Jan. 9, 2023

Related U.S. Application Data
(60) Provisional application No. 63/266,590, filed on Jan. 10, 2022.

(51) Int. Cl. G06F 16/335; G06F 40/279

(52) U.S. Cl. CPC G06F 16/337; G06F 40/279

(57) ABSTRACT

Systems and methods comprising: analyzing an electronic resource to identify Entities in textual content (wherein each Entity comprises word(s)); performing machine learning operations to assign an entity type classification of a plurality of entity type classifications to at least one of the Entities; performing machine learning operations to assign each said Entity to one or more segments of the textual content that respectively comprise facts about people; performing machine learning operations to recognize relationships of the Entities to each person or business entity identified in the textual content and assign a relationship classification of a plurality of relationship classifications to at least one of the Entities associated with one of the recognized relationships; converting the electronic resource into relationship vectors based on outputs of the first, second and third classifiers; and controlling operations of a software application using the relationship vector.

### CROSS-REFERENCE TO RELATED APPLICATIONS

This application claims the benefit of and priority to U.S. Provisional Patent Application No. 63/266,590 which was filed on Jan. 10, 2022. The content of the Provisional Application is incorporated herein by reference in its entirety.

### BACKGROUND

There are many techniques for processing data in automated natural language processing systems and other electronic resources. Such techniques include tokenization, vectorization, Conditional Random Fields (CRFs) and RASA conversational framework. Each of these techniques are unable to organize facts of multi-person sentences in a manner that is desirable in some applications. This can make it difficult for computer systems such as document management systems, customer management systems, note taking tools, digital home assistants, chatbots, electronic systems that respond to audio prompts and other natural language processing systems to accurately parse received text to identify appropriate entity relationships in the text.

### SUMMARY

The present disclosure concerns implementing systems and methods for operating one or more computing devices. The methods comprise: analyzing, by a computing device, an electronic resource to identify Entities in textual content (wherein each Entity comprises one or more words); performing machine learning operations by a first classifier to assign an entity type classification of a plurality of entity type classifications to at least one of the Entities; performing machine learning operations by a second classifier to assign each Entity to one or more segments of the textual content that respectively comprise facts about people; performing machine learning operations by a third classifier to recognize relationships of the Entities to each person or business entity identified in the textual content and assign a relationship classification of a plurality of relationship classifications to at least one of the Entities associated with one of the recognized relationships; converting the electronic resource into relationship vectors based on outputs of the first, second and third classifiers; and controlling operations of a software application and/or an electronic device using the relationship vectors.

The electronic resource can be converted into relationship vectors by inserting at least some of the Entities as values in data statements. At least one of the Entities may be inserted as a value in a first data statement that contains a first fact about a first person or business entity, and is inserted as a value in a second data statement that contains a second fact about a second different person or business entity.

The electronic resource may comprise a multi-person sentence. In this case, an assignment of the Entity to one or more segments of textual content may indicate that the Entity has relationships with at least two people mentioned in the multi-person sentence. In this regard, the machine learning operations performed by the second classifier may comprise assigning a first Entity to both a first segment of textual content that is associated with a first person and a second segment of the textual content that is associated with a second person. The relationships of the Entities that are recognized by the third classifier comprise at least one of an educational relationship, a work relationship, a family relationship, or an interest relationship.

The computing device can control the software application by performing autonomous operations to provide facts contained in one or more of the relationship vectors, based on content of a first window of the software application or another software application that is currently being displayed on a display screen. The autonomous operations may comprise: scanning content of the first window for an identifier of a person or business entity; searching a datastore for at least one relationship vector which is associated with a person or business entity identified by the identifier; and presenting at least one fact which was retrieved from the datastore in the first window or a second window displayed concurrently with the first window. The autonomous operations may be performed without requiring a user to launch a software application configured to search stored contact information. The autonomous operations may be triggered by navigation to a particular type of website, creation of an electronic message, start of an online phone call, or start of an online meeting. The first window may comprise an electronic message window, a social networking website window, or a web conferencing window. For example, the values of a relationship vector are automatically presented on the computing device or another computing device during an online meeting based on identities of participants of the online meeting.

The implementing systems can comprise: a processor; and a non-transitory computer-readable storage medium comprising programming instructions that are configured to cause the processor to implement a method for operating one or more computing devices. The above-described methods can also be implemented by a computer program product comprising memory and programming instructions that are configured to cause a processor to perform operations.

### BRIEF DESCRIPTION OF THE DRAWINGS

The present solution will be described with reference to the following drawing figures, in which like numerals represent like items throughout the figures.

FIG. 1 is a perspective view of an illustrative system implementing the present solution.

FIG. 2 is an illustration of a computing device.

FIGS. 3-4 and 7 each provide an illustration that is useful for understanding operations of the system shown in FIG. 1.

FIG. 5 provides an illustration of window(s) being displayed on a computing device.

FIG. 6 provides a flow diagram of an illustrative method for processing electronic resource(s), organizing fact(s) contained therein in datastore(s), and selectively presenting the fact(s).

FIG. 8 provides a flow diagram of an illustrative method for controlling one or more computing devices.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present solution may be embodied in other specific forms without departing from its spirit or essential characteristics. The described embodiments are to be considered in all respects only as illustrative and not restrictive. The scope of the present solution is, therefore, indicated by the appended claims rather than by this detailed description. All changes which come within the meaning and range of equivalency of the claims are to be embraced within their scope.

Reference throughout this specification to features, advantages, or similar language does not imply that all the features and advantages that may be realized with the present solution should be or are in any single embodiment of the present solution. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One skilled in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

Reference throughout this specification to “one embodiment”, “an embodiment”, or similar language means that a particular feature, structure, or characteristic described in connection with the indicated embodiment is included in at least one embodiment of the present solution. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

As noted above, there are many techniques for processing data in electronic resources. Such techniques include tokenization, vectorization, CRFs and RASA conversational framework. Each of these techniques are unable to organize facts of multi-person sentences in a manner that is desirable in some applications. For example, these conventional techniques prohibit a single word from participating in multiple relationships. The present solution provides a novel technique that addresses the drawbacks of these conventional data processing techniques.

The novel technique generally performs attribution of facts to multiple individuals identified in textual content (which may include multi-person sentence(s)) of electronic resource(s). This attribution facilitates an improved organization of facts in multi-person sentences that is useful in some applications. These applications include, but are not limited to, data storage applications, searchable datastore applications, personal/professional contact management, client relations, marketing and/or employee management, as employed in document management systems, digital home assistants, chatbots, electronic systems that respond to audio prompts or other natural language processing systems that need to parse received text to identify appropriate entity relationships in the text.

The present solution concerns implementing systems and methods for operating computing device(s). The methods comprise: receiving or otherwise obtaining an electronic resource by a computing device; analyzing the electronic resource to identify Entities in textual content (where each Entity comprises one or more words); providing the Entities to classifiers; performing machine learning operations by a first classifier that is trained to assign an entity type classification to at least one of the Entities; performing machine learning operations by a second classifier that is trained to assign each Entity to segment(s) of the textual content that respectively comprise fact(s) about people; performing machine learning operations by a third classifier that is trained to recognize relationships of the Entities to each person identified in the textual content and assign a relationship classification to at least one of the Entities associated with one of the recognized relationships; inserting the Entity(ies) as values in data statements based on outputs of the first, second and third classifiers; and populating a searchable datastore with the data statements. An Entity may be inserted as a value in a first data statement that contains a first fact about a first person and also inserted as a value in a second data statement that contains a second fact about a second different person.

The electronic resource may comprise a multi-person sentence. Assignment(s) of an Entity to segment(s) of textual content may indicate that the Entity has relationships with two or more people mentioned in the multi-person sentence. For example, the second classifier assigns the Entity to both a first segment of textual content that is associated with a first person and a second segment of the textual content that is associated with a second person. The relationships of the Entities that are recognized by the third classifier can include, but are not limited to, an educational relationship, a work relationship, a family relationship, and/or an interest relationship.

The methods may also comprise: performing, by the computing device or another computing device, autonomous operations to provide fact(s) contained in the data statement(s), based on content of a first window currently being displayed on a display screen. The first window can include, but is not limited to, an electronic message window, a social networking website window, or a web conferencing window. The autonomous operations can include, but are not limited to: scanning content of the first window for an identifier; searching the searchable datastore for data statement(s) which is(are) associated with a person or business entity identified by the identifier; and presenting fact(s) which was(were) retrieved from the searchable datastore in the first window or a second window displayed concurrently with the first window. The autonomous operations are performed without requiring a user to launch a software application configured to search stored contact information. The autonomous operations may be triggered by navigation to a particular type of website, creation of an electronic message, start of an online phone call, or start of an online meeting. In the online meeting scenarios, the values of the data statement(s) may be automatically presented on the computing device or another computing device during an online meeting based on identities of participants of the online meeting.

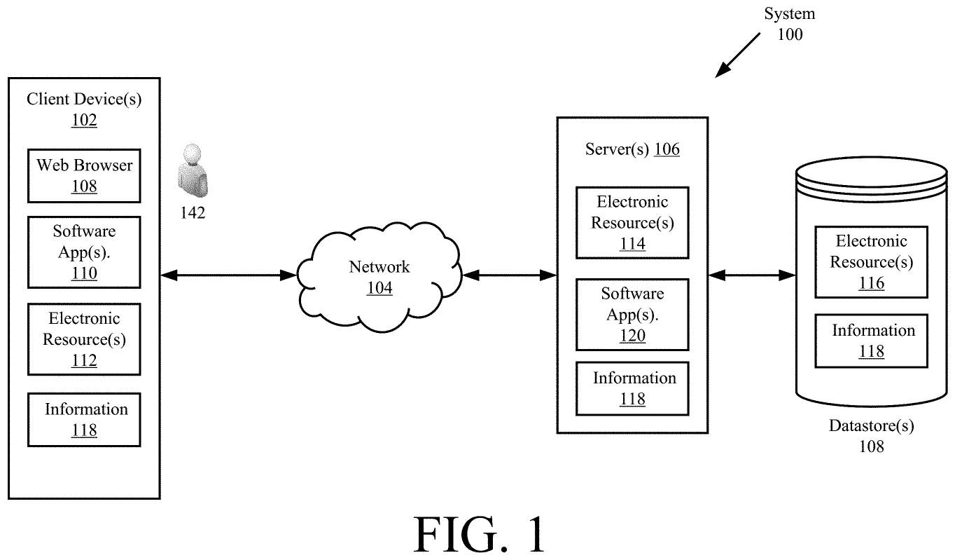

Referring now to FIG. 1, there is provided an illustration of a system 100 implementing the present solution. System 100 is generally configured to process and classify textual content contained in electronic resource(s) 112, 114, 116. The electronic resource(s) can include, but are not limited to, populated form(s), electronic mail message(s), Word document(s), graphic(s), Portable Document Format (PDF) document(s), and/or other documents with textual content. In some scenarios, speech recognition and transcription may be employed to generate electronic resource(s) (for example, during video calls and use of other real-time communication platforms). The textual content comprises text in a human-readable format and in any language (for example, English, Spanish, etc.). The electronic resource(s) 112, 114, 116 can be stored on client device(s) 102, server(s) 106 and/or datastore(s) 108. The electronic resource(s) 112, 114, 116 can be processed by the client device(s) 102 and/or server(s) 106. Accordingly, the client device(s) 102 are communicatively coupled to the server(s) 106 via network 104 (for example, the Internet or Intranet). The data processing operations may be implemented as software application(s) 110 executed by the client device(s) 102 and/or software application(s) 120 executed by the server(s) 106. In some scenarios, the server(s) 106 provide(s) cloud service(s) for such data processing. The cloud service(s) can be accessed by the client device(s) 102 using web browser(s) 108. Results from the data processing can be stored in local datastore(s) of the client device(s) 102, local datastore(s) of the server(s) 106, and/or remote datastore(s) 108.

During operation, the client device(s) 102 and/or server(s) 106 generally process textual content to identify people, business entities and relationships therebetween. For example, the textual content includes the following sentence: “Alex went to University-A, works at Company-A and his wife June works at Company-B.” The client device(s) 102 and/or server(s) 106 perform(s) operations to discover that: (i) two people (namely, Alex and June) are referenced in the sentence; (ii) there is a relationship between a first person of the two people and University-A and the relationship is of an education type; (iii) there is a relationship between the first person and Company-A and the relationship is of an employer type; (iv) there is a relationship between the first person and a second person of the two people and the relationship is of a family type; and (v) there is a relationship between the second person and Company-B and the relationship is of an employer type.

The discovered information is then stored as information 118 in an accessible and searchable format. The user 142 may simply query the database(s) for information 118 and view query responses via web browser 108 and/or software application 110. Additionally or alternatively, the information 118 can be automatedly retrieved from the datastore(s) (i.e., with any input/prompt from user 142) as the user navigates to/from online tools (for example, online video conference tool) and/or web sites (for example, social media sites).

For example, user 142 accesses a particular person's web page (for example, Alex's web page) of a social media site using web browser 108 of client device 102. As the user 142 views this web page, the system automatically/automatedly retrieves information 118 from the datastore(s) that is associated with the particular person, formats the retrieved information for display to the user, and causes the formatted information to be presented in a Graphical User Interface (GUI) which is displayed on a display of the client device along with the particular person's web page (for example, Alex's web page). At a later time, user 142 participates in a video conference using an online tool. During the video conference, the system accesses the video conference information to obtain contact information (for example, email addresses) for the participants, and uses the contact information to retrieve information 118 from the datastore(s) that is associated with the same. The retrieved information is formatted for display to the user. Once formatted, the system causes the formatted information to be presented in a GUI which is displayed on a display of the client device along with the video conference window. The GUI may also comprise widget(s) to allow the user 142 to enter textual content associated with one or more of the participants. The system then performs operations to update the stored information associated with the same. The system may also monitor the audio content of the video conference and convert the same to textual content for further processing in accordance with the present solution. The present solution is not limited to the particulars of this example.

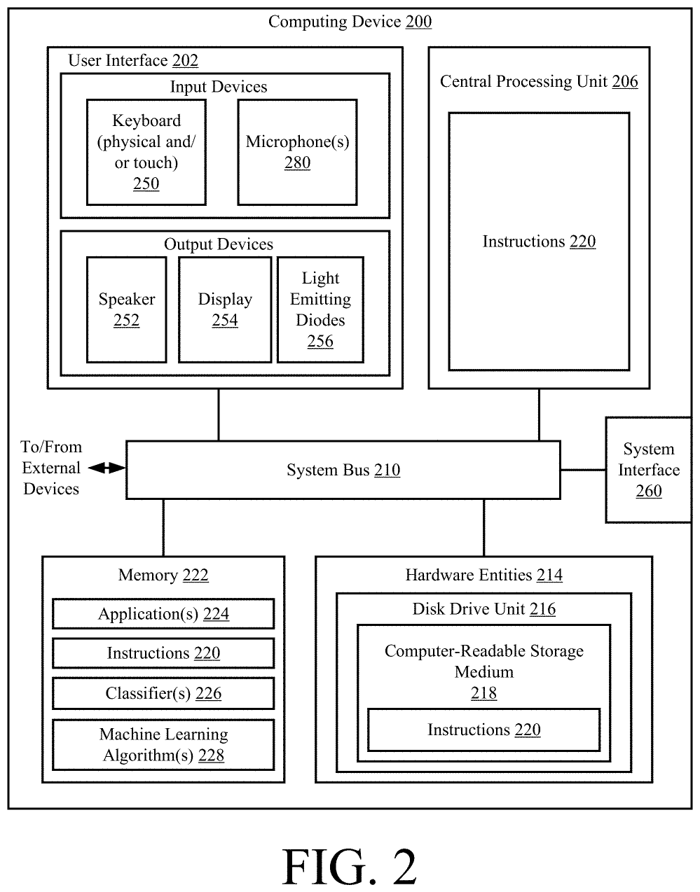

Referring now to FIG. 2, there is provided a detailed block diagram of an exemplary architecture for a computing device 200. Client device(s) 102 and/or server(s) 106 can be the same as or similar to computing device 200. As such, the discussion of computing device 200 is sufficient for understanding client device(s) 102 and/or server(s) 106. Computing device 200 includes, but is not limited to, a personal computer, a desktop computer, a laptop computer, a personal digital assistant, a smart device (for example, a smartphone) and/or a headset (for example, smart glasses or 3D goggles).

Computing device 200 may include more or less components than those shown in FIG. 2. However, the components shown are sufficient to disclose an illustrative embodiment implementing the present solution. The hardware architecture of FIG. 2 represents one embodiment of a representative computing device configured to facilitate attribution of facts to multiple individuals identified in textual content (which may include multi-person sentences). As such, the computing device 200 of FIG. 2 implements at least a portion of the methods described herein in relation to the present solution.

Some or all the components of the computing device 200 can be implemented as hardware, software and/or a combination of hardware and software. The hardware includes, but is not limited to, one or more electronic circuits. The electronic circuits can include, but are not limited to, passive components (for example, resistors and capacitors) and/or active components (for example, amplifiers and/or microprocessors). The passive and/or active components can be adapted to, arranged to and/or programmed to perform one or more of the methodologies, procedures, or functions described herein.

As shown in FIG. 2, the computing device 200 comprises a user interface 202, a Central Processing Unit (CPU) 206, a system bus 210, a memory 212 connected to and accessible by other portions of computing device 200 through system bus 210, and hardware entities 214 connected to system bus 210. The user interface can include input devices (for example, a keypad 250 and/or microphone(s) 280) and output devices (for example, speaker 252, a display 254, and/or light emitting diodes 256), which facilitate user-software interactions for controlling operations of the computing device 200. Speech captured by the microphone(s) 208 can be transcribed by CPU 206 into a written representation thereof in accordance with any known or to be known technique. The display can include, but is not limited to, a touch screen display or other display screen.

At least some of the hardware entities 214 perform actions involving access to and use of memory 212, which can be a RAM, and/or a disk driver. Hardware entities 214 can include a disk drive unit 216 comprising a computer-readable storage medium 218 on which is stored one or more sets of instructions 220 (for example, software code) configured to implement one or more of the methodologies, procedures, or functions described herein. The instructions 220 can also reside, completely or at least partially, within the memory 212 and/or within the CPU 206 during execution thereof by the computing device 200. The memory 212 and the CPU 206 also can constitute machine-readable media. The term “machine-readable media”, as used here, refers to a single medium or multiple media (for example, a centralized or distributed database, and/or associated caches and servers) that store the one or more sets of instructions 220. The term “machine-readable media”, as used here, also refers to any medium that is capable of storing, encoding or carrying a set of instructions 220 for execution by the computing device 200 and that cause the computing device 200 to perform any one or more of the methodologies of the present disclosure.

In some scenarios, the hardware entities 214 include an electronic circuit (for example, a processor) programmed for facilitating attribution of facts to multiple individuals identified in textual content (which may include multi-person sentences). In this regard, it should be understood that the electronic circuit can access and run one or more software applications 224 installed on the computing device 200. The software application(s) 224 is(are) generally operative to: receive user inputs defining textual content of an electronic resource(s); store electronic resource(s) in datastore(s); access electronic resource(s) stored in datastore(s); extract textual content of electronic resource(s); tokenize the textual content; classify textual content of electronic resource(s); generate formatted data based on the classifications of the textual content to facilitate attribution of facts to particular individuals (or persons) identified in the textual content (which may include multi-person sentences); store the formatted data in datastore(s); facilitate data searches relating to the formatted data from the datastore(s); and reformat and/or present formatted data to user(s). Other functions of the software application(s) 224 will become apparent as the discussion progresses.

The tokenization of the textual content generally involves converting phrases (each of which is a reference to an entity) into relationship vectors. Briefly, the difference between an Entity and a Reference is that each entity can be referred to in multiple ways so that the platonic entity NEW_YORK_CITY could be referenced as NY or The Big Apple. The tokenization technique implemented by the software application(s) 224 is capable of disambiguation. For instance, the software application(s) 224 can map the word “apple” in “she works at apple” to a different entity than the “apple” in “she ate an apple”. The software application(s) 224 is also robust to misspellings and case misuse.

The software application(s) 224 may also encode each entity as a vector in a high dimensional space (for example, 768 dimensions). This operation facilitates discovery of semantically similar concepts which lie near each other in the vector space. The directions in the vector are meaningful. For instance, the direction corresponding to the vector difference v(QUEEN)−v(KING) is similar to v(WOMAN)−v(MAN). Thus unprompted, the software application(s) 224 has(have) the notion of Gender.

The classifications of textual content can be achieved using classifier(s) 226. The classifier(s) 226 can include, but is(are) not limited to, an entity type classifier, a person-segment classifier and a relationship classifier. The classifier(s) 226 can be implemented using an open source machine learning framework (for example, RASA), CRF model(s), probability distribution-based classifiers (for example, random field classifiers), and/or neural network-based algorithms. The textual content can include one or more sentences and/or phrases with or without punctuation marks and/or emojis. The classifiers may process each sentence and/or phrase separately. Alternatively, the classifiers may ignore the punctuation marks, and therefore may process a plurality of sentences and/or phrases during a single iteration of a classification process. In some scenarios, emojis are associated with people and business entities. Thus, the system may be configured to convert the emojis into a textual representation (for example, Alex) that can be processed along with other textual content of the electronic resource(s). Operations of the classifiers can be performed sequentially or in parallel.

The entity type classifier is generally configured to detect specific words in textual content of electronic resource(s) and assign an entity type classification to the specific words. The words can include, but are not limited to, names of individual(s) (or person(s)), names of organization(s) (for example, schools, universities, and/or business entities), and/or words that specify relationships between people. Once the specific words are detected, an entity type classification is assigned to the same. The entity type classification can include, but is not limited to, Name, Organization, Work Organization, City and/or Relationship Type. For example, the textual content includes the following sentence “He enjoyed being at the Big Apple.”. The software application(s) 224 detect(s) the words “Big Apple”, consider(s) the same as a single entity, and provide(s) the words as an entity input to the entity type classifier. The entity type classifier classifies this entity (i.e., Big Apple) as being of the type City. The present solution is not limited to the particulars of this example. Entities that comprise verbs, adjectives, conjunctions, pronouns and prepositions may not be classified by the entity type classifier. In some scenarios, the entity type classifier generates (for each entity) a confidence score for each entity type class and assign the entity type class with the best confidence score to the entity.

The person-segment classifier is generally configured to identify portions of the textual content which are associated with and/or include facts about each detected person. For example, the textual content comprises the following sentence “Alex went to University-A and his wife June went to University B”. The person-segment classifier recognizes that the portion “Alex went to University-A and his wife June” of the textual content is associated with and includes facts about Alex, and therefore assigns each entity in the same to a Person-1 segment class. This portion of the textual content includes four entities: Alex, went, to, and University-A. The person-segment classifier also recognizes that the portion “June went to University-B” of the textual content is associated with and includes facts about June, and therefore assigns each entity thereof to a Person-2 segment class. This portion of the textual content includes four entities: June, went, to, and University-B. The present solution is not limited to the particulars of this example.

The relationship classifier is generally configured to recognize relationships between entities and assign the entities to pre-defined relationship classes based on the recognized relationships. The relationship classes can include, but are not limited to, education, employer, family, and/or friend. For example, the textual content includes the following sentence “Alex went to University-A and his wife June went to University B”. The relationship classifier recognizes that: (i) the entity University-A is an educational organization and therefore assigns this entity to the education class; (ii) the entity June is the wife of Alex and therefore assigns this entity to the family class; and (iii) the entity University B is an educational organization and therefore assigns this entity to the education class. The present solution is not limited to the particulars of this example. In some scenarios, the relationship classifier generates (for each entity) a confidence score for each relationship class and assign the relationship class with the best confidence score to the entity.

The tokenization, vectorization and/or classification operations described above can be facilitated using machine learning algorithm(s) trained using training data to detect patterns in textual content that indicate certain information (for example, classes) with levels of confidence. The machine learning algorithms can employ supervised machine learning, semi-supervised machine learning, unsupervised machine learning, and/or reinforcement machine learning. Each of these listed types of machine-learning algorithms is well known in the art. In some scenarios, the machine-learning algorithm includes, but is not limited to, a decision tree learning algorithm, an association rule learning algorithm, an artificial neural network learning algorithm, a deep learning algorithm, an inductive logic programming based algorithm, a support vector machine based algorithm, a Bayesian network based algorithm, a representation learning algorithm, a similarity and metric learning algorithm, a sparse dictionary learning algorithm, a genetic algorithm, a rule-based machine-learning algorithm, and/or a learning classifier system based algorithm. The machine-learning process implemented by the present solution can be built using Commercial-Off-The-Shelf (COTS) tools.

Once the classifiers and/or machine learning algorithm(s) have completed their operations, the results thereof are further processed by the software application(s) 224 to generate and store datastore entries defining the relationships between entities detected in the textual content. For example, the following entries are generated and stored in a datastore.

EDUCATION(name=Alex, organization=University-A)
FAMILY_RELATIONSHIP(name=Alex, type=wife, otherPerson=June)
EDUCATION(name=Alex, organization=University-B)
The present solution is not limited to the particulars of this example.

The datastore entries can be queried, for example, in response to a user input and/or in response to particular content (for example, a name Alex) being contained in a web site (for example, a social media site) accessed by a user. The query response may be processed such that information including facts about one or more given persons is presented in a GUI to a user of the computing device and/or another computing device.

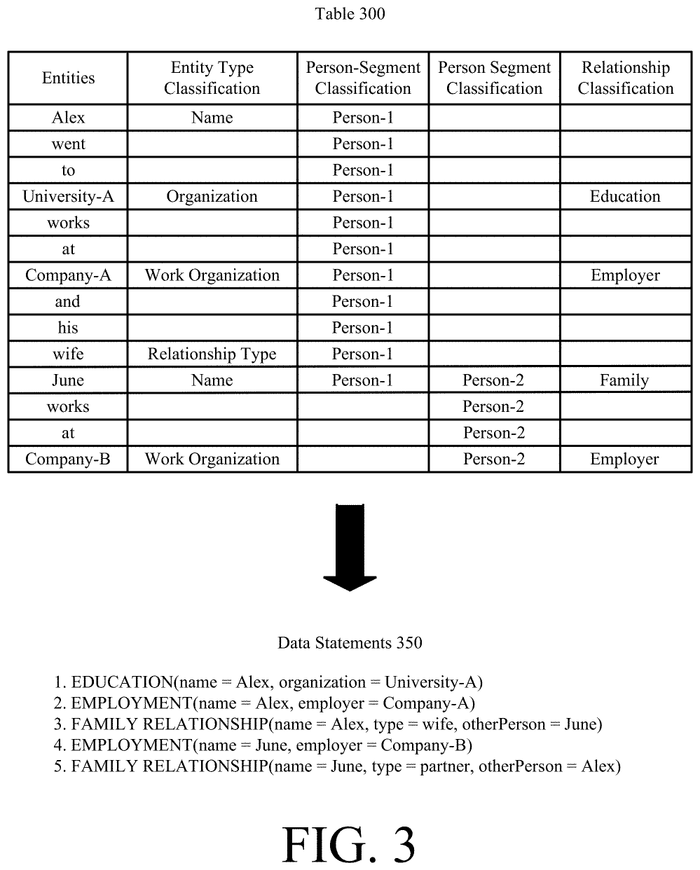

Referring now to FIG. 3, there is provided an illustration that is useful for understanding the present solution. The present solution involves converting textual content into relationship vectors. This conversion may be achieved by first generating a Table 300 comprising information of the textual content. Table 300 comprises a plurality of columns including an entities column, an entity type column, person-segment columns, and a relationship column. The entities column includes a list of entities that were identified in textual content by a software application (for example, software application 110 of FIG. 1, 112 of FIG. 1 or 224 of FIG. 2). The textual content comprises a multi-person sentence “Alex went to University-A works at Company-A and his wife June works at Company-B”. The entities comprise the following fourteen words: Alex, went, to, University-A, works, at, Company-A, and, his, wife, June, works, at, Company-B.

A row is provided in Table 300 for each entity. Each row includes the entity type classification, per-segment classification, and/or relationship classification for the respective entity. For example, a first row of Table 300 is associated with entity Alex and comprises an entity type classification Name and person-segment classification Person-1. A second row of Table 300 is associated with an entity went and comprises a person-segment classification Person-1. A third row in Table 300 is associated with the entity to and comprises a person-segment classification Person-1. A fourth row in Table 300 is associated with the entity University-A and comprises an entity type classification Organization, a person-segment classification Person-1, and a relationship classification Education. A fifth row in Table 300 is associated with the entity works and comprises a person-segment classification Person-1. A sixth row in Table 300 is associated with the entity at and comprises a person-segment classification Person-1. A seventh row in Table 300 is associated with the entity Company-A and comprises an entity type classification Work Organization, a person-segment classification Person-1, and a relationship classification Employer. An eight row in Table 300 is associated with the entity and and comprises a person-segment classification Person-1. A ninth row in Table 300 is associated with the entity his and comprises a person-segment classification Person-1. A tenth row in Table 300 is associated with the entity wife and comprises an entity type classification Relationship Type and a person-segment classification Person-1. An eleventh row in Table 300 is associated with the entity June and comprises an entity type classification Name, a person-segment classification Person-1, a person-segment classification Person-2, and a relationship classification Family. A twelfth row in Table 300 is associated with the entity works and comprises a person-segment classification Person-2. A thirteenth in Table 300 is associated with the entity at and comprises a person-segment classification Person-2. A fourteenth row in Table 300 is associated with the entity Company-B and comprises an entity type classification Work Organization, a person-segment classification Person-2, and a relationship classification Employer. The present solution is not limited to the particulars of this Table 300.

It should be noted that the sentence is partitioned by the person-segment classifier by person so that words belonging to Person-1 (for example, Alex) are separated from those belonging to Person-2 (for example, June). Given word(s) (for example, June) may belong to two or more segments. The person-segment classifier operates with the contiguity assumption that words pertaining to Person-1 will precede those pertaining to Person-2, and so on.

The information in Table 300 is then converted into data statements which are to be stored as searchable entries in datastores (for example, datastore(s) 108 of FIG. 1 and/or memory 222 of FIG. 2). Each data statement is considered a relationship vector. Within the words for a given person, the system first determines the name of that person (for example, Person-1=Alex). Within the words for Alex, the system searches the results of the classifiers for distinct relationships (for example, Education), and then searches for slots for each distinct relationship. Each relation has a special slot called Name whose value is filled by the person within which this relation occurs (for example, Education occurs within the region of Alex and so Name is given the value Alex). Each relation has one or more other slots whose values need to be filled. For relation Education, values for the following slots are filled: Name, Org, Major and TimeFrame. Org receives the value University-A and no values are found for Major or TimeFrame in this sentence.

The word June forms both the value of a slot (for Alex's Family Relation: RelationType is wife and value is June) and is also the name of another person in the sentence. For the FamilyRelation, the slots needs are: Name (primary name), RelationType, OtherPersonName and Duration. Name is easy to fill since the system is currently handling the segment of the sentence that is associated with Person-1. Furthermore, the entity type classifier output indicates that the word wife is a RelationType so that slot is filled next. Finally, OtherPerson slot is filled using the proximity assumption that is engaged when a RelationType (for example, wife) is next to a person (for example, June) as detected by the classifier(s).

In some cases, a value for one Relation can be used to a slot for a higher Relation. For example, if the system has detected: Alex.Relationship.relation type:wife; and Alex.Relationship.other person name:June. The system may combine these into the following statement where wife has moved from value to slot: Alex.Relationship.wife:June.

Accordingly, the following data statements 350 are generated using the information in Table 300.

EDUCATION(name=Alex, organization=University-A)
EMPLOYMENT(name=Alex, employer=Company-A)
FAMILY RELATIONSHIP(name=Alex, type=wife, otherPerson =June)
EMPLOYMENT(name=June, employer=Company-B)
It should be noted that entity Alex and entity June are both participants in multiple relationships of the data statements 350. The single word Entity Alex necessarily must participate in multiple relationships. This feature of the present solution is novel since conventional solutions prohibit a single word from participating in multiple relationships.

Each of the data statements 350 has a fixed pre-defined structure in which information is serially arranged to define a relationship between two Entities. The relationship can be, for example, between: two people; a person and a business entity; two business entities; a person and an activity; a person and an event; a person and a place; person and an item; a business entity and an activity; a business entity and an event; and a business entity and a place. The item can include, but is not limited to, a physical item, a virtual item, and/or a Non-Fungible Token (NFT). Each relationship of the data statements 350 has a Slot Type (for example, EDUCATION, EMPLOYMENT, or FAMILY RELATIONSHIP) and a plurality of Slot Fields (for example, name, organization, employer, relationship type, and/or otherPerson). The data statement structure can be generally defined as follows.

ST(SF1=SV1, . . . , SFN=SVN)

where ST represents a Slot Type, SF1 and SFN each represents a Slot Field Type, and SV1 and SVN represent variable Slot Values. Entities are inserted as the Slot Values (for example, Alex, University-A, Company-A, wife, June, and Company-B) associated with the Slot Field Types.

Each relationship type has a pre-defined data statement structure. So, for instance, a BOOK relationship which captures what books are liked by which people only admit three Slot Values—reader name, book name and genre. There can be multiple instances of one relationship type (for example, EMPLOYMENT) in one sentence or phrase. In this case, multiple data statements with the same Slot Type can be generated.

In some scenarios, the system is also configured to identify backwards relationship tagging. For example, the system can determine that Alex is a partner of June and create the following additional data statement.

FAMILY RELATIONSHIP(name=June, type=partner, otherPerson=Alex)

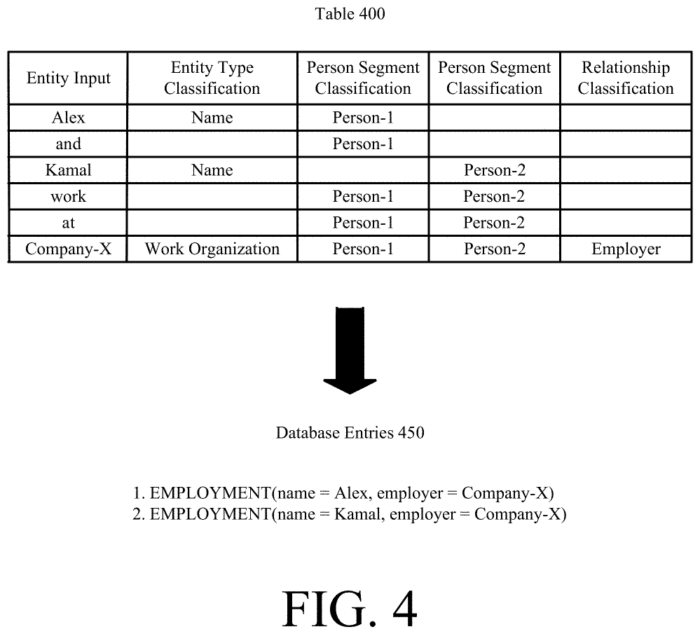

Referring now to FIG. 4, there is provided an illustration that is useful for understanding the present solution. Table 400 comprises a plurality of columns including an entities column, an entity type column, person-segment columns, and a relationship column. The entities column includes a list of entities that were identified in textual content by a software application (for example, software application 110 of FIG. 1, 112 of FIG. 1 or 224 of FIG. 2). The textual content comprises a multi-person sentence “Alex and Kamal work at Company-X”. The entities comprise the following words: Alex, and, Kamal, work, at, Company-X.

A row is provided in Table 400 for each entity. Each row includes the entity type classification, per-segment classification, and/or relationship classification for the respective entity. For example, a first row of Table 400 is associated with entity Alex and comprises an entity type classification Name and a person-segment classification Person-1. A second row of Table 400 is associated with entity and and comprises a person-segment classification Person-1. A third row of Table 400 is associated with entity Kamal and comprises an entity type classification Name and a person-segment classification Person-2. A fourth row of Table 400 is associated with entity work and comprises a person-segment classification Person-1 and a person-segment classification Person-2. A fifth row of Table 400 is associated with entity at and comprises a person-segment classification Person-1 and a person-segment classification Person-2. A sixth row in Table 400 is associated with entity Company-X and comprises an entity type classification Work Organization, a person-segment classification Person-1, a person-segment classification Person-2, and a relationship classification Employer. The present solution is not limited to the particulars of this Table 400.

The information in Table 400 is then converted into data statements which are to be stored as searchable entries in datastores (for example, datastore(s) 108 of FIG. 1 and/or memory 222 of FIG. 2). For example, the following data statements 450 are generated using the information in Table 400.

EMPLOYMENT(name=Alex, employer=Company-X)
EMPLOYMENT(name=Kamal, employer=Company-X)
In this case, there are multiple instances of one relationship type (for example, EMPLOYMENT) in the same sentence.

It should be noted that the system may also be configured to detect people's interests. There is provided an illustration that is useful for understanding this feature of the present solution. Table 700 comprises a plurality of columns including an entities column, an entity type column, person-segment columns, and an interest column. The entities column includes a list of entities that were identified in textual content by a software application (for example, software application 110 of FIG. 1, 112 of FIG. 1 or 224 of FIG. 2). The textual content comprises a sentence “Alex went surfing at the beach”. The entities comprise the following words: Alex, went, surfing, at, the, beach.

A row is provided in Table 700 for each entity. Each row includes the entity type classification, per-segment classification, and/or interest classification for the respective entity. For example, a first row of Table 700 is associated with entity Alex and comprises an entity type classification Name and a person-segment classification Person-1. A second row of Table 700 is associated with entity went and comprises a person-segment classification Person-1. A third row of Table 700 is associated with entity surfing and comprises an entity type classification Activity, a person-segment classification Person-1 and in interest classification Sport. A fourth row of Table 700 is associated with entity at and comprises a person-segment classification Person-1. A fifth row of Table 700 is associated with entity the and comprises a person-segment classification Person-1. A sixth row in Table 700 is associated with entity beach and comprises an entity type classification Geographic Location, a person-segment classification Person-1 and an interest classification Place. The present solution is not limited to the particulars of this Table 700.

The information in Table 700 is then converted into data statements which are to be stored as searchable entries in datastores (for example, datastore(s) 108 of FIG. 1 and/or memory 222 of FIG. 2). For example, the following data statements 750 are generated using the information in Table 700.

Interest(name=Alex, sport=surfing)
Interest(name=Alex, place=beach)
The present solution is not limited to the particulars of the data statements 750.

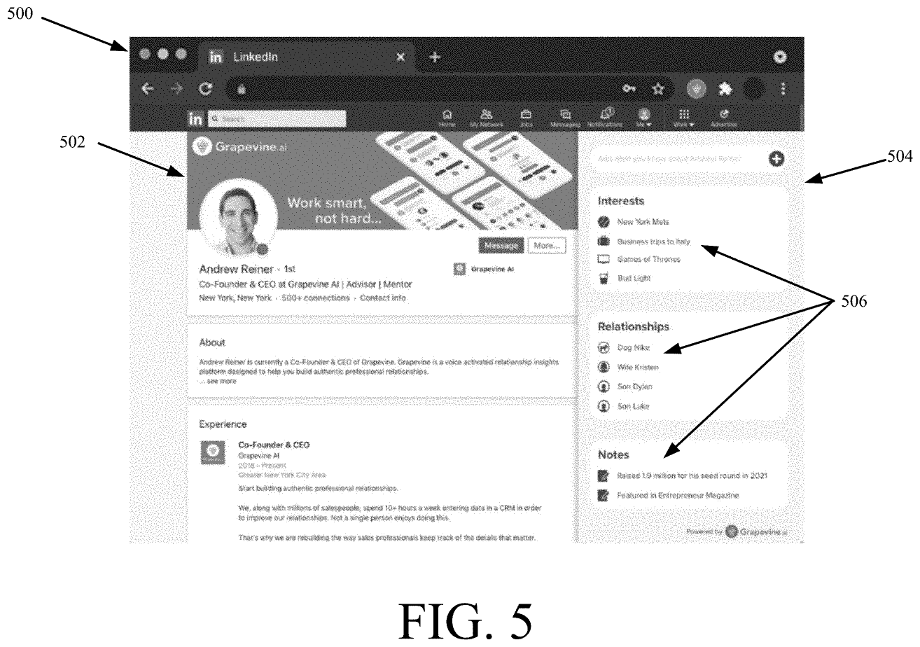

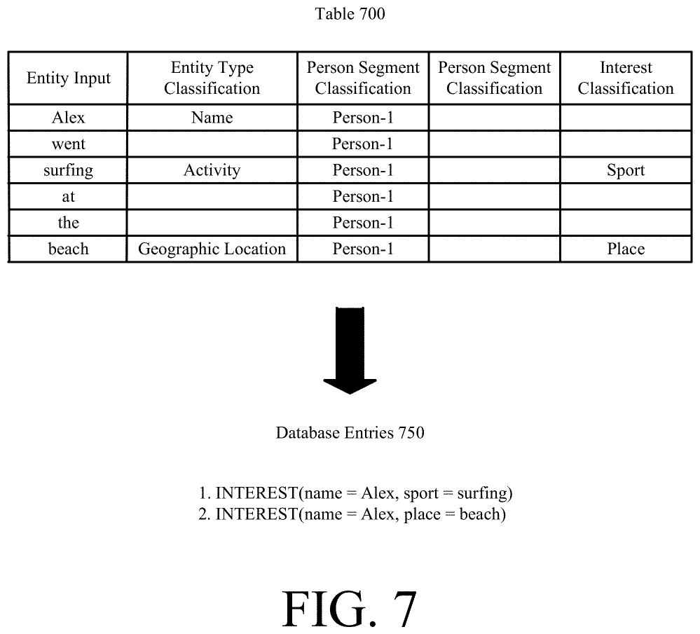

As noted above, the stored information (for example, data statements 350 of FIG. 3, 450 of FIG. 4 and/or 750 of FIG. 7) can be retrieved from datastore(s) and at least partially presented to users via GUIs of display screens. An illustration is provided in FIG. 5 that shows a web page 502 displayed in a web browser window 500. The web page 502 comprises a social media page for a particular person. A facts GUI 504 is superimposed on or otherwise displayed adjacent to the web browser window 500 and/or web page 502. Factual information 506 is presented in the GUI 504 which was extracted from textual content and organized into data statements in accordance with the present solution. The information 506 includes the slot type information (for example, Interests, Relationships, and Notes) and slot value information (for example, New York Mets, Dog Nike, Raised 1.9 million for his seed round in 2021, etc.) arranged in a pre-defined manner (for example, a manner which is user friendly and easily understood).

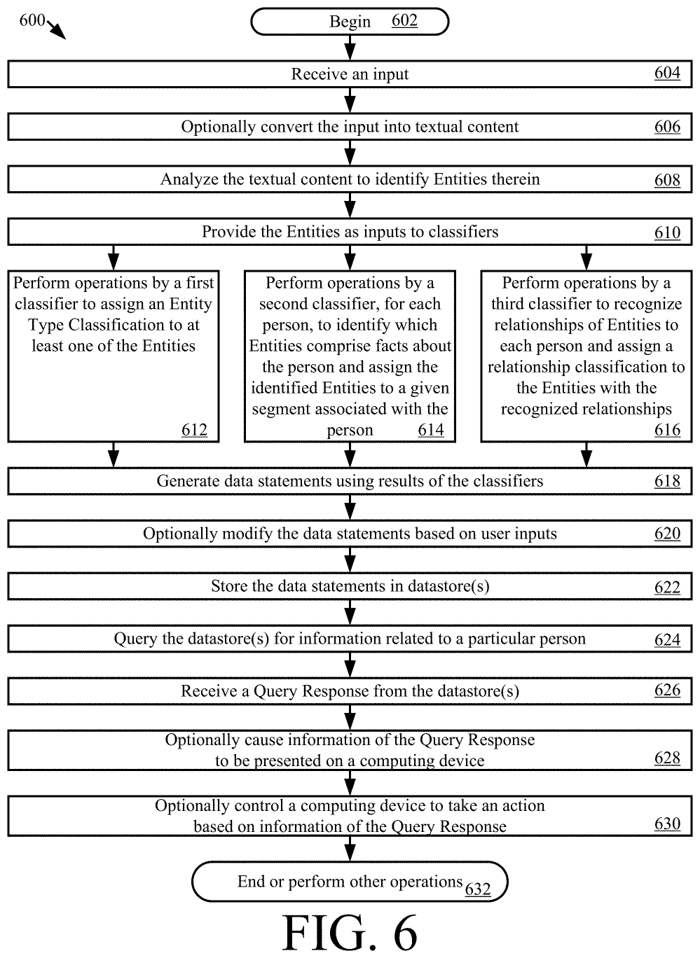

Referring now to FIG. 6, there is provided a flow diagram of an illustrative method 600 for detecting and selectively providing facts about people in accordance with the present solution. Method 600 begins with 602 and continues with 604 where a computing device (for example, client device 102 of FIG. 1 or server 106 of FIG. 1) receives an input. The input can be received, for example: via a user-software interaction for entering information into a system; in response to a user-software interaction for creating, accessing and/or updating an electronic resource; in response to a user-software interaction with a cloud-based platform; and/or from a local and/or remote datastore. The input includes electronic resource(s) containing textual content, audio content and/or graphical content. If the electronic resource(s) contain(s) non-textual content (for example, audio such as speech or graphics such as emojis), the system performs operations to convert the same to textual content as shown by optional block 606. Any known or to be known technique for converting non-textual content to textual content can be used.

In some scenarios, the computing device automatically or autonomously performs operations (for example, in the background) in 604 to detect when an electronic resource has been entered into a system or received from an external device. This detection can be facilitated by intercepting messages sent to/from local software applications of the computing device. Such a detection can trigger operations to analyze the electronic resource for people identifier(s) and/or business entity identifier(s). If no people and/or business identifiers are contained in the electronic resource, then method 600 waits until a next electronic resource is entered or received. Otherwise, method 600 continues with 606 or 608 so that a searchable database of contact information is generated and/or updated without any assistance from the user (for example, without requiring a contact index application to be launched and/or any user-software interactions for entering contact information into the contact index via a displayed window or GUI). In effect, the underlying functionality of the computing device is improved since these operations eliminate the need for specific human-software interactions for generating and/or updating a database of contact information.

In 608, the computing device analyzes the textual content to identify Entities therein. Each entity can include one or more words (for example, Alex or New York). The Entities are provided in 610 as inputs to classifiers (for example, classifiers 226 of FIG. 2) for further processing. The classifiers may operate in parallel as shown in FIG. 6 or in a serial manner (not shown).

In 612, a first classifier performs operations to assign an entity type classification to at least one of the Entities. For example, as shown in FIG. 3, the Entity University-A is assigned an entity type classification Organization, while the Entity Company-A is assigned an entity type classification Work Organization. The present solution is not limited by the particulars of this example.

In 614, a second classifier performs operations (for each person identified in the textual content) to identify which Entities comprise facts about the person and assign the identified Entities to a given segment of textual content that is associated with the person. For example, in FIG. 3, the second classifier assigned the following Entities to a first segment of textual content (for example, segment Person-1): Alex, went, to, University-A, works, at, Company-A, and, his, wife, June. The second classifier also assigns the following Entities to a second segment of textual content (for example, segment Person-2): June, works, at, Company-B. The present solution is not limited by the particulars of this example.

In 616, a third classifier performs operations to recognize relationships of Entities to each person identified in the textual content and assigns a relationship classification to the Entities with the recognized relationships. For example, in FIG. 3, the third classifier recognizes that Entity University-A has an educational relationship to Alex, and thus assigns a relationship classification Education to the Entity University-A. The third classifier also recognized that Entity Company-B has a work organization relationship with June, and thus assigns a relationship Employer to Entity Company-B. The present solution is not limited by the particulars of this example.

Once the classifiers have completed their operations, the computing device generates data statements (for example, data statements 350 of FIG. 3 or 450 of FIG. 4) using the outputs of the classifiers, as shown by 618. Each data statement has a pre-defined structure and/or pre-defined content. Thus, the computing device simply populates one or more given data statements with values for each slot thereof based on results of the classifications. For example, as shown in FIG. 3, the computing device populates a first data statement with a value Alex for a name slot and a value University-A for an organization slot. The present solution is not limited by the particulars of this example. The data statements may be presented to and/or modified by a user (for example, user 142 of FIG. 1) in optional block 620. The data statements are stored in datastore(s) (for example, datastore(s) 108 of FIG. 1 and/or memory 222 of FIG. 2) as shown by 622.

In 624, the datastore(s) is(are) queried for information related to a particular person. This query can be triggered by navigation to a particular type of website, creation of an electronic message, start of an online phone call, or start of an online meeting. The particular type of website can include, but is not limited to, a social media website, a professional website with people bios, and a networking website. This query can additionally or alternatively be responsive to a user input requesting the query, responsive to the user's navigation to a website or webpage associated with the particular person (for example, a social media web page for the particular person), responsive to the user's creation of an electronic message to the particular person, or responsive to the user's participation in an online conferencing session (for example, an audio only cloud-based session or an audio/video cloud-based session) along with the particular person. For example, the computing device can automatically or autonomously perform operations in the background (when triggered) that involve scanning content of a window or GUI being viewed by the user for any names or other identifiers for people (for example, icons and/or images). If a name/identifier for a person is detected, then the computing device can automatically query the datastore(s) for facts about the detected person. In this way, the computing device improves the user's experience since the user need not launch a separate software application for performing datastore searching, and has an increased or otherwise improved processing efficiency. The present solution is not limited to the particulars of this example.

A query response is received by the computing device in 626. The computing device may optionally cause information contained in the query response to be presented to the user using the computing device or another computing device, as shown by 628. In this regard, a processor of the computing device may control operations of a software application (for example, a web browser, electronic email application, an online phone service application, or an online meeting or conferencing application) to automatically modify content displayed in a window or GUI thereof to show information contained in the query response. The modified window or GUI may be considered a combined or consolidated window or GUI including content of the software application (for example, an electronic messaging application) and facts about people which were retrieved from a searchable database by another software application (for example, a contact index application for recoding names and facts about people) in the background (i.e., without having the user access and launch the contact index application). The combined or consolidated window or GUI provides an improved computer functionality since a single window or GUI may be presented to the user without having the user launch two separate software applications and switch between windows/GUIs of the same to access and/or view corresponding information. Additionally or alternatively, the processor can cause a software application to generate and display a new window or other GUI over or adjacent to the displayed window (for example, a web browser, electronic email application, an online phone service application, or an online meeting or conferencing application). Even in this case the computer functionality is improved since the new window or GUI is generated and displayed without requiring the user to access, launch and perform user-software interactions for causing the same, which results in improved computer processing time, an improved user experience, and less resource intensity.

In 630, operations may optionally be performed to control a computing device to take an action based on information of the Query Response. This action can include, but is not limited to, generating and presenting one or more recommended electronic messages (for example, electronic birthday card(s)), initiating a change to a contact index that records information about people, generating and providing recommendations for improving relationships with contacts (for example, initiating a meeting or sending a gift), and/or adding entries on an electronic calendar.

In view of forgoing, the operations of 624-630 implement important features of the present solution since they facilitate a more user-friendly tool for managing personal and professional contacts. For example, the computing device can cause a window or GUI of a first application (for example, a social media web site) to be dynamically modified to include content of data statements that can only be accessed by another second software application (for example, a contact management application) without having to launch the second software application and/or use the second application to search stored information for facts about people.

Subsequently, 632 is performed where method 600 ends or other operations are performed (for example, return to 602). For example, the value(s) of the data statement(s) is(are) presented on the computing device or another computing device during a videoconference based on identifies of participants of the videoconference.

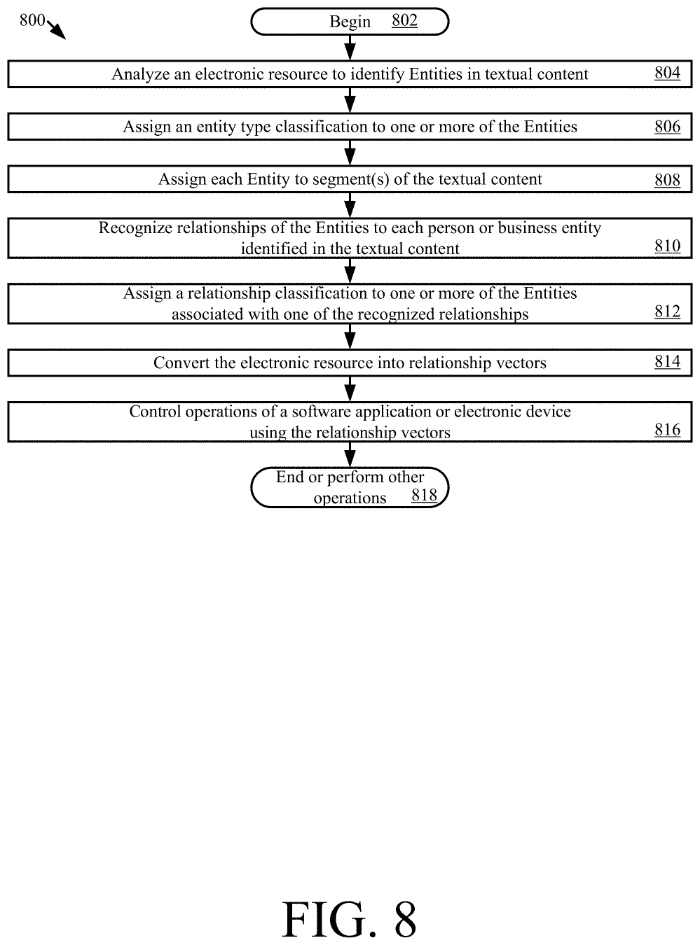

Referring now to FIG. 8, there is provided a flow diagram of a method 800 for operating one or more computing devices (for example, computing device 102 of FIG. 1, server 106 of FIG. 1, and/or computing device 200 of FIG. 2). The operations of method 800 can be performed by one or more of the computing devices.

Method 800 begins with 802 and continues with 804 where the computing device(s) analyze(s) an electronic resource to identify Entities in textual content. Each Entity comprises one or more words. In 806-812, machine learning operations are performed to: assign an entity type classification to one or more of the Entities; assign each Entity to segment(s) of the textual content; recognize relationships of the Entities to each person or business entity identified in the textual content; and assign a relationship classification to one or more of the Entities associated with one of the recognized relationships. The segments can respectively comprise facts about people and/or facts about business entities.

The electronic resource may comprise a multi-person sentence. In this case, an assignment of the Entity to one or more segments of textual content may indicate that the Entity has relationships with at least two people mentioned in the multi-person sentence. In this regard, the machine learning operations performed in block 808 may comprise assigning a first Entity to both a first segment of textual content that is associated with a first person and a second segment of the textual content that is associated with a second person. The relationships of the Entities that are recognized in 810 can include, but are not limited to, an educational relationship, a work relationship, a family relationship, and/or an interest relationship.

In 814, the computing device(s) perform operations to convert the electronic resource into relationship vectors. This conversion may be based on outputs of the machine learning operations. The electronic resource can be converted into relationship vectors by inserting at least some of the Entities as values in data statements. At least one of the Entities may be inserted as a value in a first data statement that contains a first fact about a first person and is inserted as a value in a second data statement that contains a second fact about a second different person.

Upon completing 814, the computing device(s) may control operations of a software application or an electronic device using the relationship vectors, as shown by 816. The electronic device can include, but is not limited to, a processor and/or a computing device. For example, a software application can be controlled to modify a window or GUI to include certain information contained in the relationship vector(s), to enable certain functions (for example, enable a privacy setting to prevent certain information from being provided to person identified in a relationship vector and/or related to a business entity identified in a relationship vector). An electronic device can be controlled to organize information contained in the relationship vector(s) and provide the organized information to an individual (for example, via an output device such as a display, speaker or wireless communication). Subsequently, 818 is performed where method 800 ends or other operations are performed (for example, return to 804).

In some scenarios, the computing device(s) can control the software application in 816 by performing autonomous operations to provide facts contained in one or more of the relationship vectors, based on content of a first window of the software application or another software application that is currently being displayed on a display screen. The autonomous operations may comprise: scanning content of the first window for an identifier of a person or business entity; searching a datastore for at least one relationship vector which is associated with a person or business entity identified by the identifier; and presenting at least one fact which was retrieved from the datastore in the first window or a second window displayed concurrently with the first window. The autonomous operations may be performed without requiring a user to launch a software application configured to search stored contact information. The autonomous operations may be triggered by navigation to a particular type of website, creation of an electronic message, start of an online phone call, or start of an online meeting. The first window may comprise an electronic message window, a social networking website window, or a web conferencing window. For example, the values of a relationship vector are automatically presented on the computing device or another computing device during an online meeting based on identities of participants of the online meeting.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above described embodiments. Rather, the scope of the present solution should be defined in accordance with the following claims and their equivalents.

What is claimed is:

1. A method for operating one or more computing devices, comprising:
analyzing, by the computing device, an electronic resource to identify Entities in textual content, wherein each said Entity comprises one or more words;
performing machine learning operations by a first classifier to assign an entity type classification of a plurality of entity type classifications to at least one of the Entities;
performing machine learning operations by a second classifier to assign each said Entity to one or more segments of the textual content that respectively comprise facts about people or business entities;
performing machine learning operations by a third classifier to recognize relationships of the Entities to each person or business entity identified in the textual content and assign a relationship classification of a plurality of relationship classifications to at least one of the Entities associated with one of the recognized relationships;
converting, by the computing device, the electronic resource into relationship vectors based on outputs of the first, second and third classifiers; and
controlling, by the computing device, operations of a software application using the relationship vectors.

2. The method according to claim 1, wherein the converting comprises inserting at least some of the Entities as values in a plurality of data statements.

3. The method according to claim 2, wherein at least one of the Entities is inserted as a value in a first one of the plurality of the data statements that contains a first fact about a first person or business entity and is inserted as a value in a second one of the plurality of data statements that contains a second fact about a second different person or business entity.

4. The method according to claim 1, wherein the electronic resource comprises a multi-person sentence, and an assignment of the Entity to one or more segments of textual content indicates that the Entity has relationships with at least two people mentioned in the multi-person sentence.

5. The method according to claim 1, wherein said performing machine learning operations by the second classifier further comprises assigning a first Entity of the Entities to both a first segment of textual content that is associated with a first person and a second segment of the textual content that is associated with a second person.

6. The method according to claim 1, wherein the relationships of the Entities that are recognized by the third classifier comprise at least one of an educational relationship, a work relationship, a family relationship, or an interest relationship.

7. The method according to claim 1, wherein the controlling operations of the software application comprising performing autonomous operations to provide facts contained in one or more of the relationship vectors, based on content of a first window of the software application or another software application that is currently being displayed on a display screen.

8. The method according to claim 7, wherein the autonomous operations comprise:
scanning content of the first window for an identifier of a person or business entity;
searching a datastore for at least one said relationship vector which is associated with a person or business entity identified by the identifier; and
presenting at least one said fact which was retrieved from the datastore in the first window or a second window displayed concurrently with the first window.

9. The method according to claim 7, wherein the autonomous operations are triggered by navigation to a particular type of website, creation of an electronic message, start of an online phone call, or start of an online meeting.

10. The method according to claim 7, wherein the first window comprises an electronic message window, a social networking website window, or a web conferencing window.

11. The method according to claim 7, wherein the autonomous operations are performed without requiring a user to launch a software application configured to search stored contact information.

12. The method according to claim 1, wherein the values of at least one of the relationship vectors are automatically presented on the computing device or another computing device during an online meeting based on identities of participants of the online meeting.

13. A system, comprising:
at least one processor;
a non-transitory computer-readable storage medium comprising programming instructions that are configured to cause the processor to implement a method for selectively providing facts about people, wherein the programming instructions comprise instructions to:
analyze an electronic resource to identify Entities in textual content, wherein each said Entity comprises one or more words;
perform first machine learning operations to assign an entity type classification of a plurality of entity type classifications to at least one of the Entities;
perform second machine learning operations to assign each said Entity to one or more segments of the textual content that respectively comprise facts about people;
perform third machine learning operations to recognize relationships of the Entities to each person or business entity identified in the textual content and assign a relationship classification of a plurality of relationship classifications to at least one of the Entities associated with one of the recognized relationships;
convert the electronic resource into relationship vectors based on outputs of the first, second and third classifiers; and
control operations of a software application using the relationship vectors.

14. The system according to claim 13, wherein the electronic resource is converted into relationship vectors by inserting at least some of the Entities as values in a plurality of data statements.

15. The system according to claim 14, wherein at least one of the Entities is inserted as a value in a first one of the plurality of the data statements that contains a first fact about a first person or business entity and is inserted as a value in a second one of the plurality of data statements that contains a second fact about a second different person or business entity.

16. The system according to claim 13, wherein the electronic resource comprises a multi-person sentence, and an assignment of the Entity to one or more segments of textual content indicates that the Entity has relationships with at least two people mentioned in the multi-person sentence.

17. The system according to claim 13, wherein the second machine learning operations comprise assigning a first Entity of the Entities to both a first segment of textual content that is associated with a first person and a second segment of the textual content that is associated with a second person.

18. The system according to claim 13, wherein the software application is controlled by performing autonomous operations to provide facts contained in one or more of the relationship vectors, based on content of a first window of the software application or another software application that is currently being displayed on a display screen.

19. The system according to claim 18, wherein the autonomous operations comprise:
scanning content of the first window for an identifier of a person or business entity;
searching a datastore for at least one said relationship vector which is associated with a person or business entity identified by the identifier; and
presenting at least one said fact which was retrieved from the datastore in the first window or a second window displayed concurrently with the first window.

20. A non-transitory computer-readable medium that stores instructions that are configured to, when executed by at least one computing device, cause the at least one computing device to perform operations comprising:
analyzing an electronic resource to identify Entities in textual content, wherein each said Entity comprises one or more words;
performing machine learning operations to assign an entity type classification of a plurality of entity type classifications to at least one of the Entities;
performing machine learning operations to assign each said Entity to one or more segments of the textual content that respectively comprise facts about people;
performing machine learning operations to recognize relationships of the Entities to each person or business entity identified in the textual content and assign a relationship classification of a plurality of relationship classifications to at least one of the Entities associated with one of the recognized relationships;
converting the electronic resource into relationship vectors based on outputs of the first, second and third classifiers; and
controlling operations of a software application using the relationship vectors.
